(19) United States
(12) Patent Application Publication
(10) Pub. No.: US 2018/0202484 A1
(43) Pub. Date: Jul. 19, 2018

(54) CROWNING OF A SPLINE IN A DIRECTION PERPENDICULAR TO A SPLINE TOOTH FACE

(71) Applicant: Bell Helicopter Textron Inc., Fort Worth, TX (US)

(72) Inventor: Eric Stephen Olson, Fort Worth, TX (US)

(73) Assignee: Bell Helicopter Textron Inc., Fort Worth, TX (US)

(21) Appl. No.: 15/406,745

(22) Filed: Jan. 15, 2017

(51) Int. Cl. F16C 3/02; B23F 19/00

(52) U.S. Cl. CPC F16C 3/02; B23F 19/005

(57) ABSTRACT

A drive shaft includes a plurality of external crowned spline teeth configured for transmitting torque in a drive system such that contact stress can remain substantially even as misalignments occur. The drive shaft can be manufactured by forming a groove in a drive shaft blank in a direction perpendicular to the side faces of the spline teeth being formed. The resulting spline teeth can have crowned side-wall surfaces that have equal crown drops along the height of the side walls of the spline teeth.

### TECHNICAL FIELD

This disclosure generally relates to spline connections, and more particularly, to spline connections in which one of the sets of spline teeth comprises crowned, external spline teeth.

### BRIEF DESCRIPTION OF THE DRAWINGS

Embodiments are illustrated by way of example in the accompanying figures, in which like reference numbers indicate similar parts, and in which:

FIG. 1 shows a schematic diagram of an example of a tiltrotor aircraft;

FIG. 2 shows a schematic diagram of an example of a rotorcraft;

FIG. 3 shows a detailed perspective, cutaway view of a shaft in accordance with the present disclosure;

FIG. 4 shows an end view of the shaft shown in FIG. 3;

FIG. 5 shows an end view of a prior shaft;

FIGS. 6A and 6B show manufacturing processes for forming the shaft shown in FIG. 3;

FIGS. 7A and 7B show contact stress diagrams associated with the prior shaft shown in FIG. 5; and

FIGS. 8A and 8B show contact stress diagrams associated with the shaft shown in FIG. 3.

### DETAILED DESCRIPTION

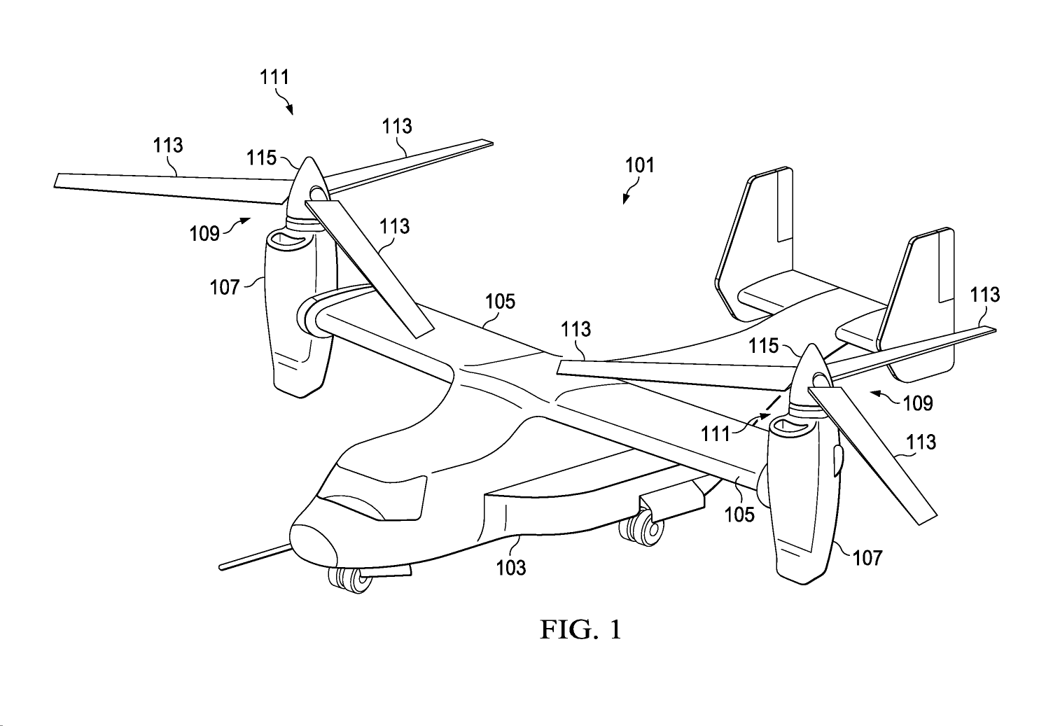

FIG. 1 shows a schematic diagram of an example tiltrotor aircraft 101. Aircraft 101 includes a fuselage 103 with attached wings 105. Nacelles 107 are carried at the outboard ends of wings 105 and are rotatable between the helicopter-mode position shown and a forward-facing airplane-mode position (not shown). Nacelles 107 carry engines and drive train subassemblies 109 for powering rotor systems 111 in rotation. An engine may be an internal combustion engine, an electrical power source and associated motor, or any other suitable means for powering rotor system 111. Each rotor system 111 is illustrated as having three blades 113. Spinning covers 115 and nacelles 107 substantially enclose drive train subassemblies 109, obscuring drive train subassemblies 109 from view in FIG. 1. The drive train subassemblies 109 can each include a gearbox, shafts, and various couplings.

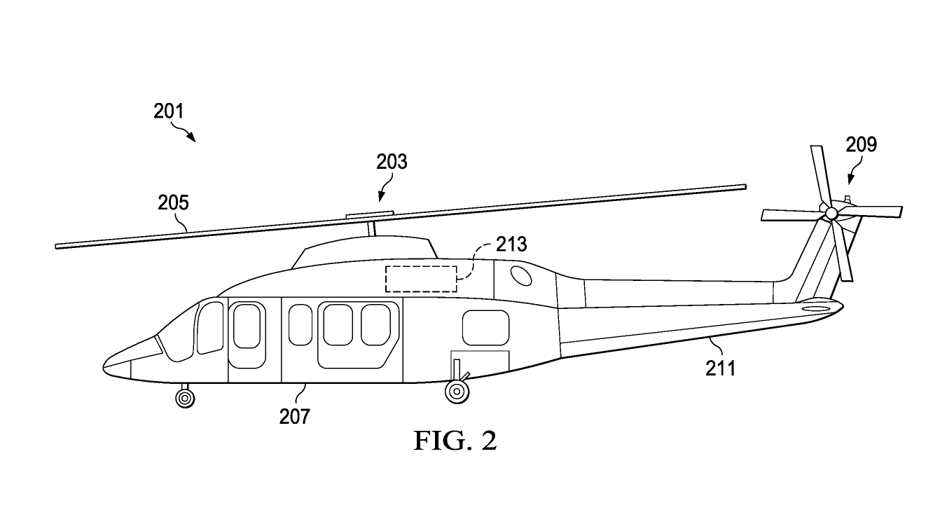

FIG. 2 shows a schematic diagram of an example rotorcraft 201. Rotorcraft 201 has a rotor system 203 with multiple rotor blades 205. The pitch of each rotor blade 205 can be manipulated in order to selectively control direction, thrust, and lift of rotorcraft 201. Rotorcraft 201 can further include a fuselage 207, anti-torque system 209, and an empennage 211. The rotorcraft 201 includes a drive train, including a drive train subassembly generally indicated at 213 for driving the rotor system 203. The drive train subassembly 213 can include a gearbox, shafts, and couplings.

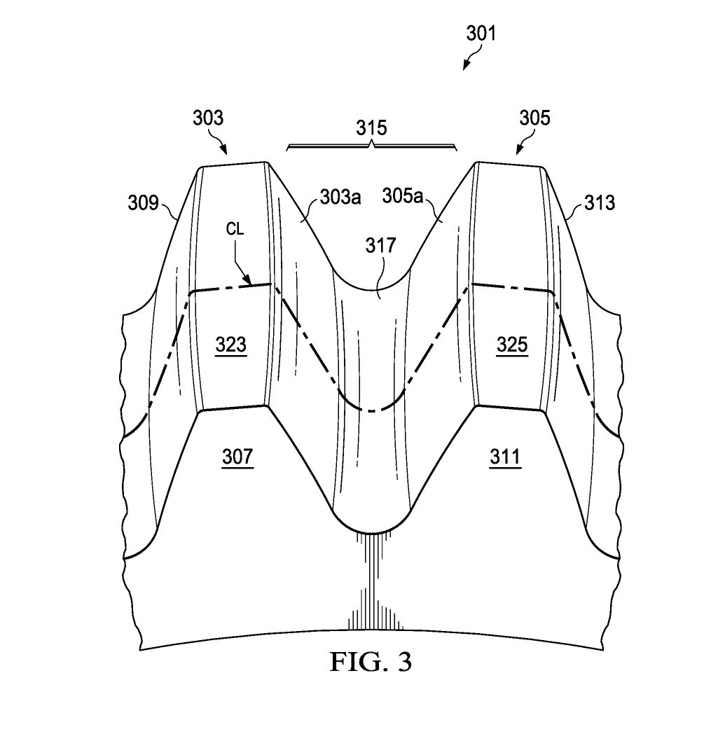

FIG. 3 shows a detailed perspective, cutaway view of a shaft 301 manufactured or otherwise configured in accordance with the present disclosure. The shaft 301 can be used as part of the drive train subassembly 109 or drive train subassembly 213, both of which include various spline connections. The present disclosure is applicable wherever a shaft, such as shaft 301, is provided with a set of crowned external spline teeth for transmitting torque to or from an internal spline. The present disclosure is particularly advantageous where the axis of the shaft having the external spline is not parallel to the axis of the element associated with the internal spline.

The shaft 301 includes first and second spline teeth 303, 305. The first spline tooth 303 extends longitudinally between a front surface 307 thereof and a rear surface 309 thereof. The second spline tooth 305 extends longitudinally between a front surface 311 thereof and a rear surface 313 thereof. Also, the first spline tooth 303 includes a tooth side wall 303a that extends from a root portion 317 to a tip portion 323 of the tooth 303, and the second spline tooth 305 includes a tooth side wall 305a that extends from the root portion 317 to a tip portion 325 of the tooth 305. The first and second spline teeth 303, 305 are separated by a groove 315. The spline teeth 303, 305 and groove 315 are representative of a series of equally spaced spline teeth and grooves that extend about the outside of the shaft 301. The first and second spline teeth 303, 305 are crowned and have an involute form. Also, as discussed in greater detail below, the spline teeth 303, 305 are configured to allow for angular misalignment between the shaft 301 and mating spline connections.

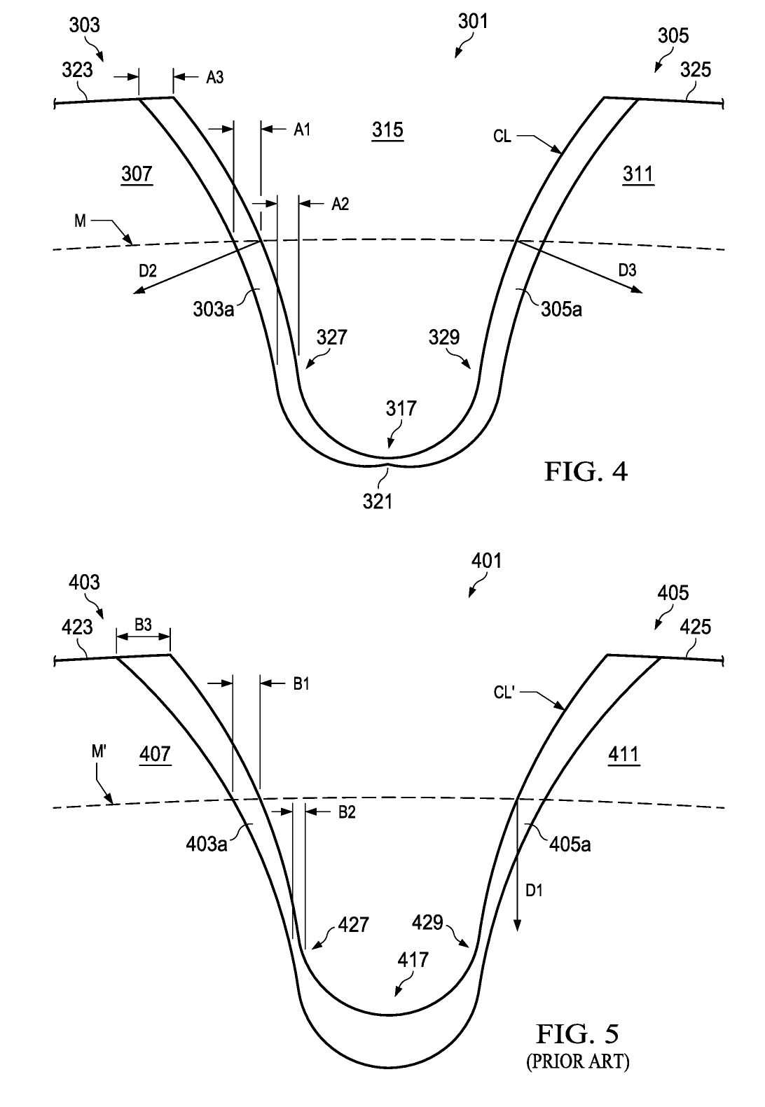

Reference is now also made to FIG. 4, which shows an end view of a portion of the first and second spline teeth 303, 305 and the groove 315. As shown in FIG. 4, the adjoining spline teeth 303, 305 are joined by a full fillet root portion 317. However, the shape of the root portion 317 can vary. For example, the root portion 317 can alternatively be a flat root as opposed to a filet root.

As shown in FIGS. 3 and 4, the spline teeth 303, 305 are crowned such that their respective side walls 303a, 305a each have a crown drop between a centerline CL across the spline teeth 303, 305 and their respective front surfaces 307, 311. The crown drop is also equally present between the centerline CL the rear surfaces 309, 313. The crown drop dimension is typically measured at the midpoint (along line M) of the teeth side walls 303a, 305a between the root portion 317 and the respective tip portions 323, 325. The midpoint crown drop dimension is shown in FIG. 4 as crown drop A1.

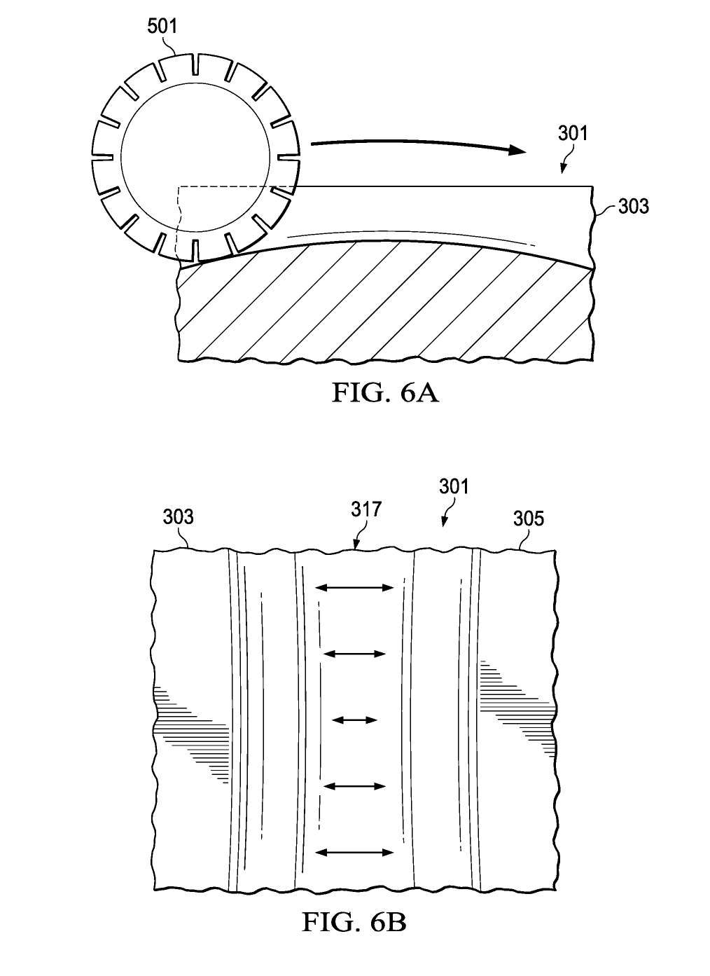

FIG. 5 shows an end view of a prior shaft 401. Shaft 401 includes a root portion 417 between adjoining spline teeth 403 and 405. Like shaft 301, the shaft 401, the teeth 403, 405 are crowned such that their respective side walls 403a, 405a each have a crown drop between a centerline CL′ across the spline teeth 403, 405 and their respective front surfaces 407, 411. The crown drop dimension is typically measured at the midpoint region (along line M′) of the teeth side walls 403a, 405a between the root portion 417 and the respective tip portions 423, 425. The midpoint crown drop dimension is shown in FIG. 5 as crown drop B1.

Referring to FIGS. 4 and 5, it will be noted that additional crown drop dimensions can be defined near the respective tips and roots of the spline teeth. In FIG. 4, a second crown drop dimension A2 is defined from the centerline CL to the respective front surfaces 307, 311 of the teeth 303, 305 at respective base portions 327, 329 near the root portion 317 of the teeth 303, 305. Also in FIG. 4, a third crown drop dimension A3 is defined from the centerline CL to the respective front surfaces 307, 311 of the teeth 303, 305 near the respective tip portions 323, 325 of the teeth 303, 305. Similarly, in FIG. 5, a second crown drop dimension B2 is defined from the centerline CL′ to the respective front surfaces 407, 411 of the teeth 403, 405 at respective base portions 427, 429 near the root portion 417 of the teeth 403, 405. Also in FIG. 5, a third crown drop dimension B3 is defined from the centerline CL to the respective front surfaces 407, 411 of the teeth 403, 405 near the respective tip portions 423, 425 of the teeth 403, 405.

Comparing FIGS. 4 and 5, it should be noted that the spline shaft 301 of the present disclosure has a consistent crown drop along the sides of the teeth 303, 305. For example, the crown drop dimensions A1, A2, and A3 are equal or substantially equal. In contrast, the crowning of the teeth 403, 405 changes along the sides of the teeth 403, 405 such that the crown drop dimension B1 is greater than B2 and is less than B3.

The phenomenon that causes the varying crown drops in the prior spline shaft 401 results from prior manufacturing processes that involved plunging a grinding wheel radially into a spline shaft blank (direction D1 in FIG. 5) and then drawing the grinding wheel 501 in a “rise-and-fall” motion along the longitudinal length of the blank to form the teeth 403, 405. However, as will be explained in greater detail below, the inconsistent crowning along the height of the teeth 403, 405 results in undesirable contact patterns between the teeth 403, 405 and teeth of another spline that is driving or being driven by the shaft 401.

Turning next to FIGS. 6A and 6B, the crowned spline teeth 303 and 305 can be manufactured by a process that includes “rise-and-fall” longitudinal milling, as shown in FIG. 6A, in combination with lateral milling, as shown in FIG. 6B. FIG. 6A shows a cross-sectional view of the shaft 301 during a manufacturing process where a grinding wheel 501 proceeds to cut the groove 315 as the grinding wheel 501 is fed axially toward the shaft 301 blank and drawn longitudinally in a direction indicated by the arrow in FIG. 6A that is somewhat parallel to the blank's axis of rotation. However, as the grinding wheel 501 is fed axially toward the shaft 301 blank, the shaft 301 is rotated about its axis in directions indicated in FIG. 6B, resulting in the grinding wheel 501 plunging into the shaft 301 blank at least twice between the teeth 303, 305, once in each of the directions D2 and D3 indicated in FIG. 4, which are at least somewhat perpendicular to the faces of the spline teeth 303 and 305.

It should be understood that the grinding operation shown in FIG. 6A can be combined with the grinding operation shown in FIG. 6B by maintaining the spline shaft 301 blank in a fixed position and plunging the milling wheel 501 into the shaft 301 blank in the directions D2 and D3. It is also noted that since the milling wheel 501 is plunged into the shaft 301 blank in both the directions D2 and D3 (perpendicular to the wall of each of the teeth 303, 305), a ridge 321 can result in the root portion 317.

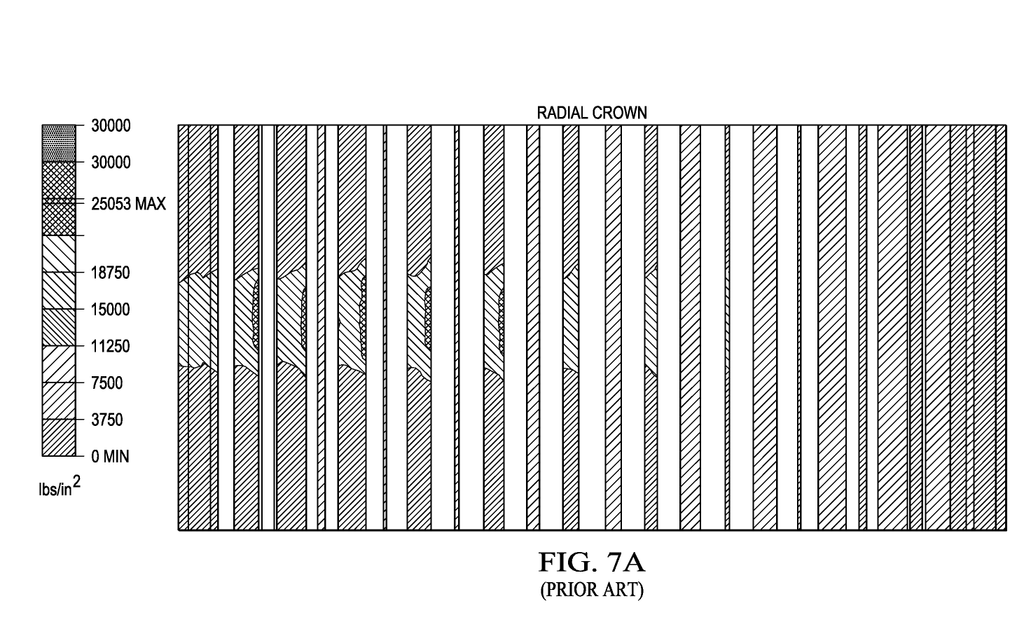

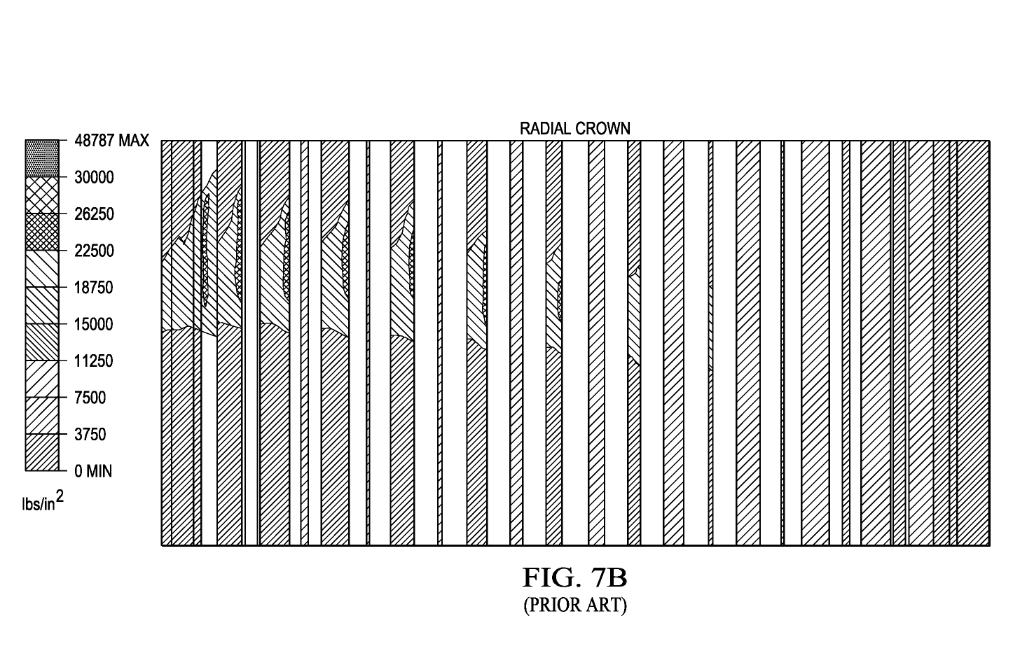

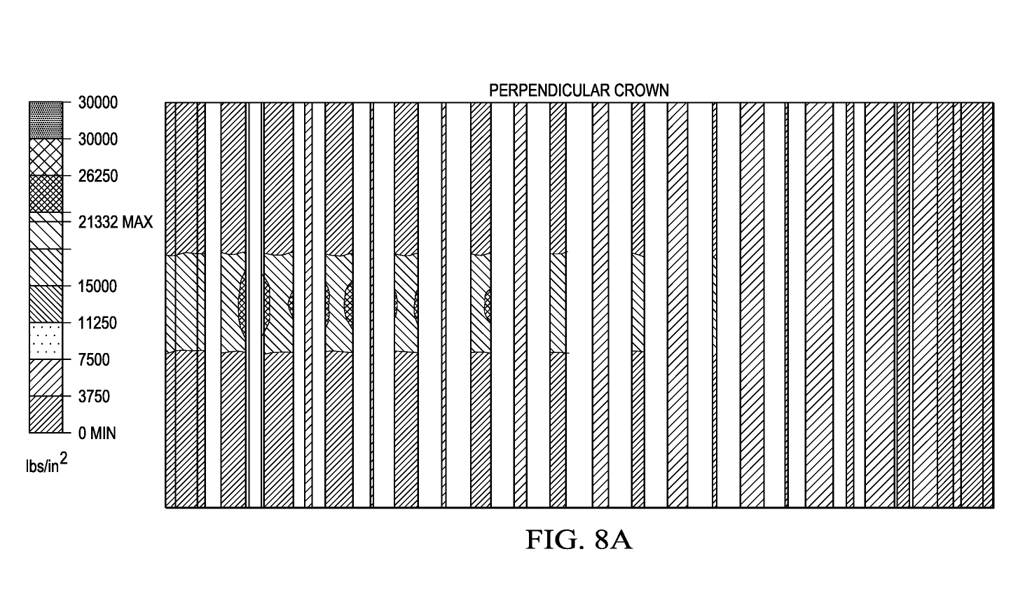

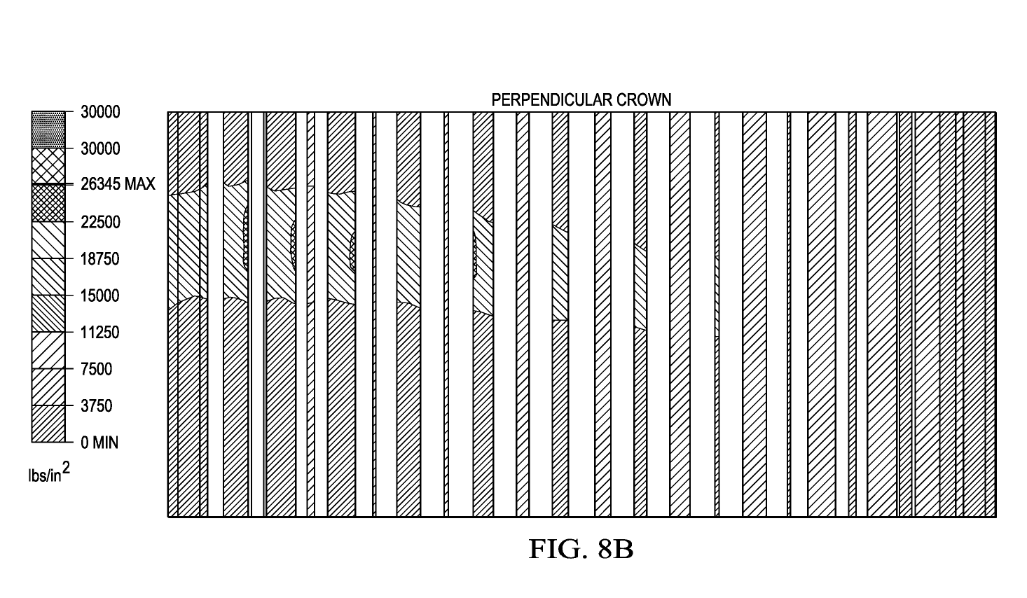

Turning next to FIGS. 7A-8B, the crowning between the spline teeth 303 and 305 that results from the manufacturing process disclosed herein eliminates much of the edge loading seen with radial crowns as the shaft 301 is misaligned with teeth of a connected gear or the like. This reduction in contact stress at higher misalignments can be useful in situations where the weight and envelope space for a spline is constrained, such as in aircraft applications. For example, FIG. 7A shows a diagram indicating the loading between spline teeth when prior shaft 401 is substantially aligned with mating spline teeth and FIG. 7B shows a diagram indicating the loading between spline teeth when prior shaft 401 is substantially misaligned with mating spline teeth. As shown in FIG. 7B, as misalignment increases, the stress pattern between contacting spline teeth also becomes increasingly uneven using prior spline crowning designs and manufacturing processes. FIG. 8A shows a diagram indicating the loading between spline teeth when the present shaft 301 is substantially aligned with mating spline teeth and FIG. 8B shows a diagram indicating the loading between spline teeth when the present shaft 301 is substantially misaligned with mating spline teeth. Compared to FIG. 7B, FIG. 8B shows that as misalignment increases, the stress pattern between contacting spline teeth continues to maintain a more even contact stress pattern as a result of the crowning disclosed herein.

While various embodiments in accordance with the principles disclosed herein have been described above, it should be understood that they have been presented by way of example only, and are not limiting. Thus, the breadth and scope of the claims should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

What is claimed is:

1. A drive shaft comprising:
a first external crowned spline tooth including a first spline tooth side wall extending from a first base portion to a first tip portion of the first spline tooth, the first spline tooth further including a first midpoint region between the first base portion and the first tip portion;
a second external crowned spline tooth having a second spline tooth side wall extending from a second base portion to a second tip portion of the second spline tooth, the second spline tooth further including a second midpoint region between the second base portion and the second tip portion; and
wherein the first spline tooth side wall has a first crown drop at the midpoint region thereof, and
wherein the first spline tooth side wall has a second crown drop equal to the first crown drop at the first base portion thereof.

2. The drive shaft of claim 1, further comprising a groove defined by the first and second spline tooth side walls between the first and second spline teeth.

3. The drive shaft of claim 2, wherein the groove is further defined by a root portion between the first and second base portions of the first and second spline teeth.

4. The drive shaft of claim 3, wherein the root portion is a filet root portion.

5. The drive shaft of claim 1, wherein the first spline tooth side wall has a third crown drop equal to the first crown drop at the first tip portion thereof.

6. The drive shaft of claim 1, wherein the first crown drop is between a centerline of the first spline tooth and a front surface of the first spline tooth.

7. The drive shaft of claim 1, wherein the second spline tooth side wall has a second crown drop equal to the first crown drop at the second midpoint region thereof.

8. A drive shaft comprising:
a first external crowned spline tooth including a first spline tooth side wall extending from a first base portion to a first tip portion of the first spline tooth, the first spline tooth further including a first midpoint region between the first base portion and the first tip portion;
a second external crowned spline tooth having a second spline tooth side wall extending from a second base portion to a second tip portion of the second spline tooth, the second spline tooth further including a second midpoint region between the second base portion and the second tip portion; and
a groove defined by the first and second spline tooth side walls between the first and second spline teeth, and further defined by a root portion between the first and second base portions of the first and second spline teeth,
wherein the first spline tooth side wall has a first crown drop at the midpoint region thereof, and
wherein the first spline tooth side wall has a second crown drop equal to the first crown drop at the first tip portion thereof.

9. The drive shaft of claim 8, further comprising a groove defined by the first and second spline tooth side walls between the first and second spline teeth.

10. The drive shaft of claim 9, wherein the groove is further defined by a root portion between the first and second base portions of the first and second spline teeth.

11. The drive shaft of claim 10, wherein the root portion is a filet root portion.

12. The drive shaft of claim 8, wherein the first spline tooth side wall has a third crown drop equal to the first crown drop at the first base portion thereof.

13. The drive shaft of claim 8, wherein the first crown drop is between a centerline of the first spline tooth and a front surface of the first spline tooth.

14. The drive shaft of claim 8, wherein the second spline tooth side wall has a second crown drop equal to the first crown drop at the second midpoint region thereof.

15. A drive shaft comprising:
a first external crowned spline tooth including a first spline tooth side wall extending from a first base portion to a first tip portion of the first spline tooth, the first spline tooth further including a first midpoint region between the first base portion and the first tip portion;
a second external crowned spline tooth having a second spline tooth side wall extending from a second base portion to a second tip portion of the second spline tooth, the second spline tooth further including a second midpoint region between the second base portion and the second tip portion; and
a groove defined by the first and second spline tooth side walls between the first and second spline teeth, and further defined by a root portion between the first and second base portions of the first and second spline teeth,
wherein the first spline tooth side wall has a first crown drop at the base region thereof, and
wherein the first spline tooth side wall has a second crown drop equal to the first crown drop at the first tip portion thereof.

16. The drive shaft of claim 15, further comprising a groove defined by the first and second spline tooth side walls between the first and second spline teeth, and further defined by a root portion between the first and second base portions of the first and second spline teeth.

17. The drive shaft of claim 16, wherein the root portion is a filet root portion.

18. The drive shaft of claim 15, wherein the first spline tooth side wall has a third crown drop equal to the first crown drop at the first midpoint region thereof.

19. The drive shaft of claim 15, wherein the first crown drop is between a centerline of the first spline tooth and a front surface of the first spline tooth.

20. The drive shaft of claim 15, wherein the second spline tooth side wall has a second crown drop equal to the first crown drop at the second midpoint region thereof.
